(19) United States
(12) Patent Application Publication
(10) Pub. No.: US 2009/0158921 A1
(43) Pub. Date: Jun. 25, 2009

(54) PERSONAL SECURITY BRACELET

(76) Inventor: DAVID JAMES NORMAN, Gabriola (CA)

Correspondence Address: J. GORDON THOMSON, P.O. BOX 8865, VICTORIA, BC, V8V 3Z1, CA

(21) Appl. No.: 12/116,093

(22) Filed: May 6, 2008

Related U.S. Application Data
(60) Provisional application No. 61/015,351, filed on Dec. 20, 2007.

(51) Int. Cl. B64D 1/00; F42B 12/36

(52) U.S. Cl. 89/1.11; 102/502

(57) ABSTRACT

A battery powered personal security device is designed to be worn on the wrist of a wearer like a bracelet. The device includes an electrical circuit adapted to generate a discharge voltage of around 1500 volts sufficient to deter an attacker but not cause tissue damage. There are two adjacent electrodes that protrude through the sloped front face of the device. The sloped front face is adapted to contact facial skin and when the electrodes are in simultaneous contact with the skin of the attacker the device discharges.

### RELATED APPLICATIONS

This application claims the benefit of provisional patent application No. 61015351 filed in the United States Patent and Trademark Office on Dec. 20, 2007.

### FIELD OF THE INVENTION

This invention pertains to security devices that are worn on the person and in particular to a personal security bracelet that is adapted to discharge electricity onto the skin of an attacking person at a voltage sufficiently high so as to deter an attack but not to cause tissue damage.

### BACKGROUND OF THE INVENTION

Security devices that discharge electricity are well known. Examples include the TASER™ family of Electronic Control Devices (ECD) manufactured by TASER International. The TASER™ C2 is a self-defense ECD using propelled wires or direct contact to conduct electrical energy onto the body of an attacker. The electrical discharge can be as high as 50,000 volts in order to affect the sensory and motor functions of the nervous system of a potential attacker. The TASER C2 uses a replaceable cartridge, containing compressed nitrogen, to deploy two small probes that are attached to the TASER C2 by insulated conductive wires with a maximum length of 15 feet (4.5 meters). The probes can penetrate up to two cumulative inches of clothing.

This type of stand-off device works best when the individual has sufficient time to deploy it from a purse or holster. In other situations, such as when an individual is ambushed without warning, the TASER-type device is not effective as there is no time to deploy, aim and fire the device.

Hand-held TASER-type devices are also available for personal security. These devices are often kept in a purse or similar container. The obvious disadvantage with this type of device is that if a person is attacked without warning then it is almost impossible to retrieve the device from its storage location in order to use it against the attacker.

Therefore, there is a continued need for a close-in deterrent device that is capable to delivering a sufficient electrical shock to an attacker and is worn on the body so that pre-deployment is not necessary.

### SUMMARY OF THE INVENTION

The shortcomings of the prior art are resolved by the provision of a personal security device to be worn securely on a person comprising: a body having a sloped front face having an angle of approximately 60 degrees and a vertical rear face, means for power storage in electrical communication the said body, means for generating a discharge voltage; and, means for discharging the discharge voltage onto the skin of an attacker sufficient to deter the attacker without tissue damage. The invention is adapted to be worn as a bracelet on the wrist of a person and is secured by an adjustable strap. The means for discharging the discharge voltage comprises a first exposed electrode and an adjacent second exposed electrode adapted for communicating the discharge voltage onto the skin of the attacker. The electrodes protrude from the sloped front face of the body. When the electrodes are in simultaneous contact with the skin of the attacker the discharge voltage will discharge. The electrodes are in contact with a voltage storage capacitor which is in contact with the high voltage side of a transformer housed within the body of the invention. The invention is powered by at least one DC battery and typically an AA or MA sized battery although other sizes can be used. The discharge voltage is in the range of 1500 volts.

In another example of the invention there is provided a “dead man switch” which must be depressed in order for the device to discharge. This prevents a person from being stuck on the discharging electrodes.

### DESCRIPTION OF THE DRAWINGS

FIG. 1 is a schematic of the electrical circuit of one example of the invention.

FIG. 2 is a front view of one example of the invention placed on the wrist of a wearer.

FIG. 3 is a top view of one example of the invention.

FIG. 4 is a rear view of one example of the invention.

FIG. 5 is a side view of one example of the invention.

FIG. 6 is a schematic of the electrical circuit of another example of the invention.

### DESCRIPTION OF THE INVENTION

The drawings enclosed herein illustrate at least one example of the invention which is a personal security bracelet. The following descriptions and the figures, to which it refers, are provided for the purpose of describing examples and specific embodiments of the invention only and are not intended to exhaustively describe all possible examples and embodiments of the invention. Many specific implementations of the personal security bracelet described herein that a person skilled in the art would see as novel and inventive.

The invention is intended to be used as a personal security device for people who feel somewhat uncomfortable in their immediate surroundings and require some extra security and protection. The invention provides this extra security and protection inexpensively and effectively. Some applications of the invention include: persons walking late at night in the city or wilderness, to repel an unwanted intrusion of personal space by people or animals, persons walking in areas of known high crime; to defend against animal/dog attack, jogging alone or walking alone. The invention is well adapted for use by individual citizens as well as by law enforcement personnel.

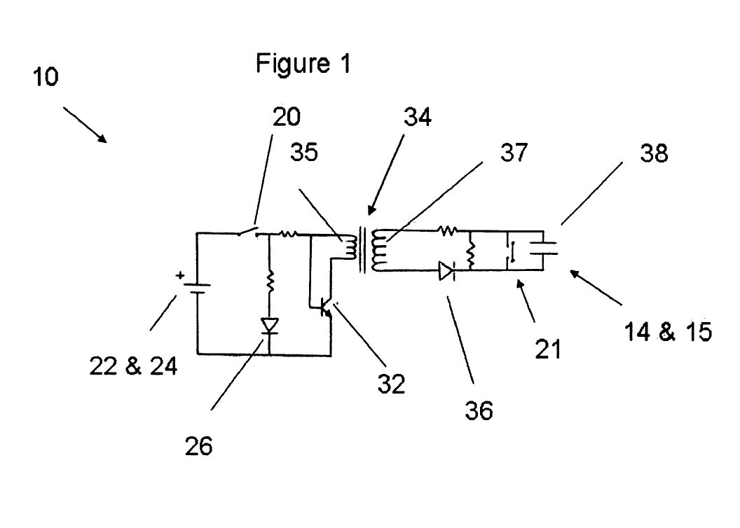

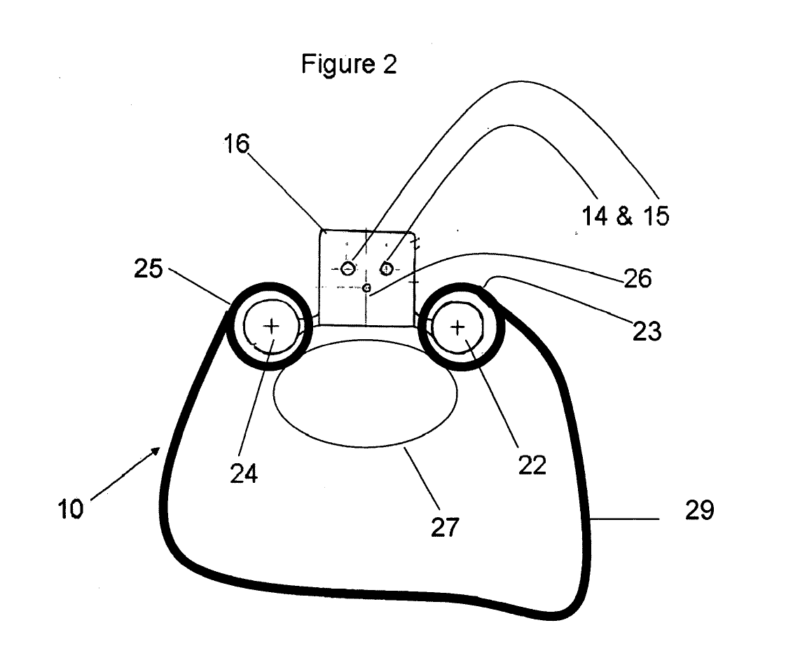

Referring now to FIG. 1 and FIG. 2, there is shown a schematic of the circuit of the invention 10. On the low voltage side of the circuit there is at least one battery but generally two batteries stored in casings 22 and 24. These can be AA or AAA sized batteries but other even smaller high voltage batteries can be used such a mini 12 volt batteries. The batteries are in series with an on/off switch 20 and connected to LED 26. LED 26 is on when the device is switched on and fully charged with a discharge voltage. The circuit also includes transistor 32 and the low voltage coil 35 of transformer 34. On the high voltage side of the circuit there is the high voltage coil 37 of transformer 34 in series with diode 36 and connected to the discharge switch 21, the capacitor 38 and the discharge electrodes 14 and 15. A person skilled in the art will realize that this circuit is but one example of a discharge voltage generating circuit and that other circuits can be used to generate and safely store a discharge voltage of desired magnitude.

Referring to FIG. 2, there is shown a front view schematic drawing of one example of the invention 10 placed on the wrist 27 of a wearer. The invention comprises body 16, battery casings 22 and 24, discharge electrodes 14 and 15 and LED 26. The LED shows when the device is “on” and “off” and remains illuminated when the device is fully charged with a discharge voltage. This drawing shows the relationship between the various components of invention 10 and a person skilled in the art of design would understand that the invention is intended to adapt a comfortable profile so that it can be worn for long periods and easily deployed against an attacker. Other profiles are possible. The size of the invention is shown to a generally accurate scale with respect to the wrist 27 of the wearer. It can be configured to be smaller than illustrated depending on the type of battery used and circuit design. The device is secured to the wrist 27 of the wearer by adjustable strap 29 which is looped around the battery casings 22 and 24 by loops 23 and 25. The strap is adjusted by a VELCRO™ type loop and hook fastener or some other suitable means. As previously mentioned, the battery casings 22 and 24 do not necessarily have to be connected to the body 16 as shown but can be independent of the body 16 for attachment elsewhere on the user in a battery magazine, for example, a battery magazine worn on a waist belt.

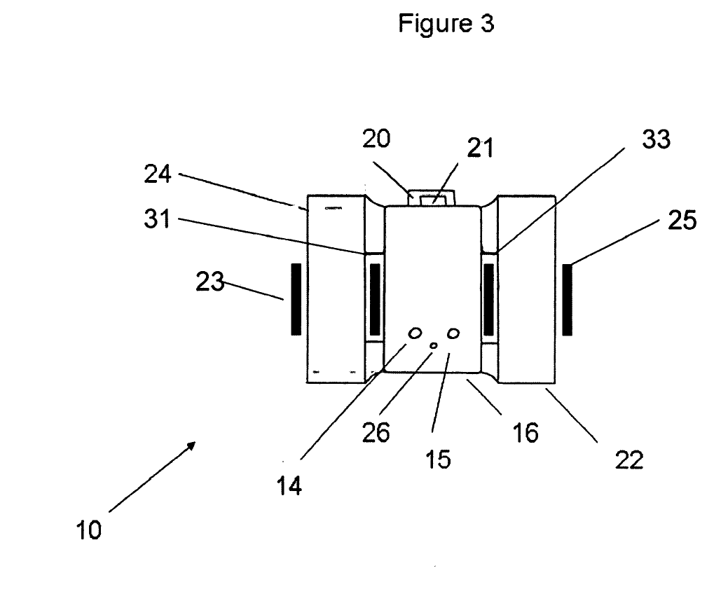

Referring to FIG. 3, there is shown a top view schematic drawing of one example of the invention 10 comprising a body 16 containing the circuitry shown in FIG. 1 and the battery casings 22 and 24, the LED 26, the discharge electrodes 14 and 15, the on/off switch 20 and the discharge button 21. Loops 23 and 25 are shown in cross section around the battery casings 22 and 24 and through slots 31 and 33 between the battery casings and the body 16 of the device. The discharge button permits discharge of the capacitor so that the invention can be stored safely in a discharged state.

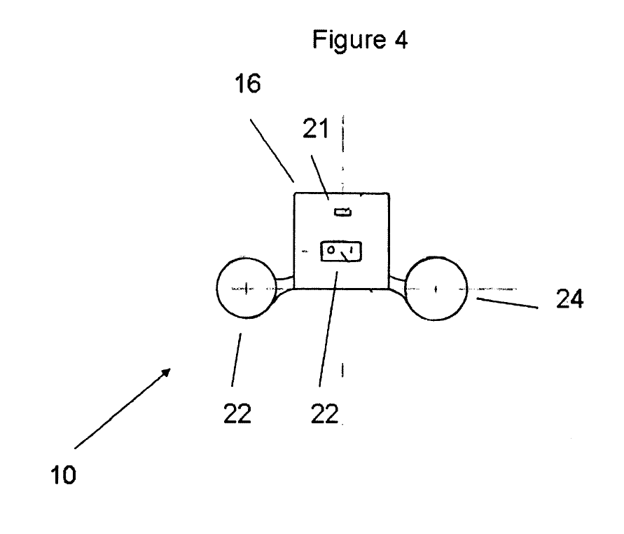

Referring to FIG. 4, there is shown a schematic drawing of a rear view 20 of one example of the invention 10 with the strap omitted. The invention comprises body 16, an on/off switch 20, a discharge button 21 disposed above the on/off switch and the batteries 22 and 24.

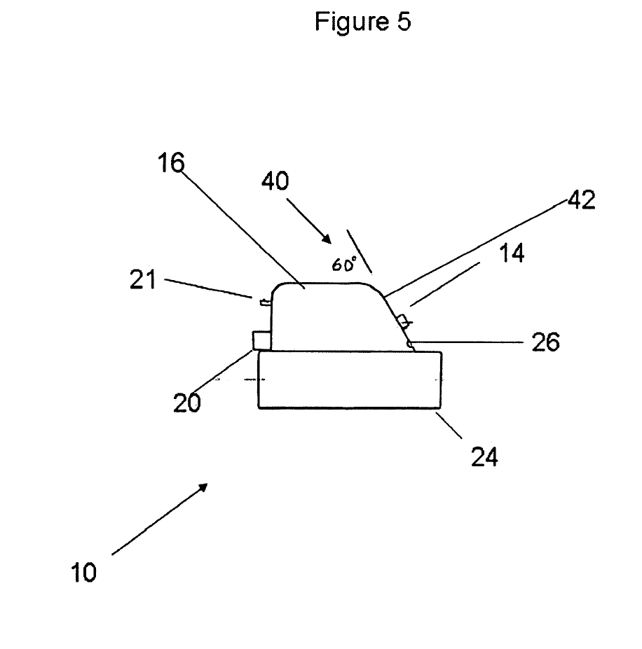

Referring to FIG. 5, there is shown a side view of on example of the invention 10 without the strap and comprising body 16, an on/off switch 20, a discharge button 21, battery casing 24, discharge electrode 14 and LED 26. The angle 40 of the front face 42 is illustrated as being 60 degrees. This is one optimum angle of attack for the electrodes to ensure that they contact the skin of the attacker simultaneously so the capacitor is able to discharge. Other embodiments of the invention with other profiles of body 16 may have different optimum attack angles.

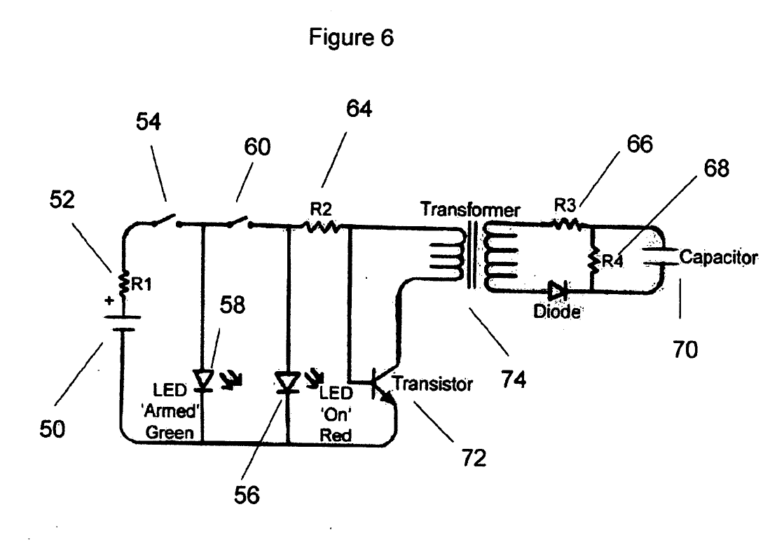

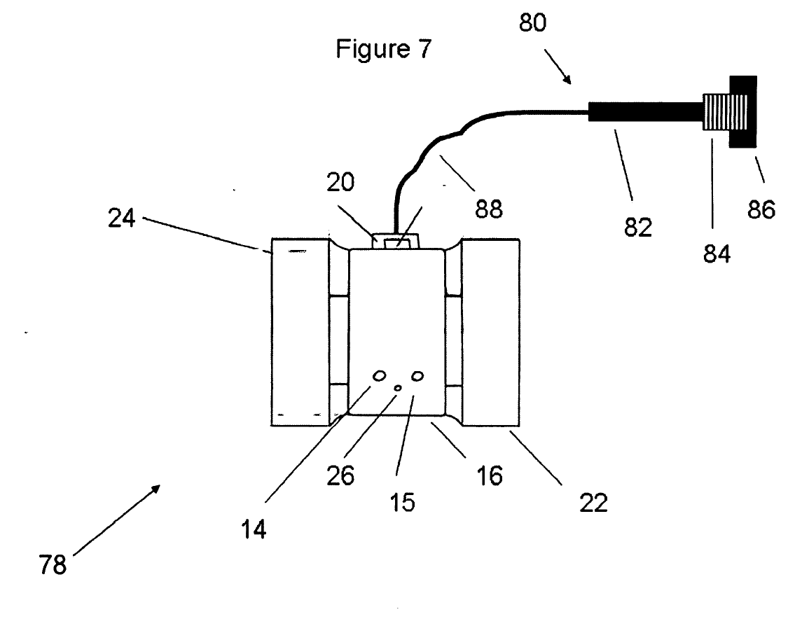

Referring to FIG. 6, there is shown an electrical schematic drawing of another example of the invention. The voltage source 50 is a pair of 1.5V AAA size batteries although other battery sizes and voltages can be used with the invention. Resistor R1 52 is about 7.5 k ohms. First switch 54 is the on/off switch for the device and LED 56 glows red when the device is on. When the device is fully charged LED 58 glows green. Second switch 60 is a hand-held switch like a “dead man's switch” which must be closed in order to discharge the device. The switch would be in the hand of the wearer like a spring trigger. When depressed the device is capable of discharging but when no depressed the device is not able to discharge or ceases discharge. This prevents the contacts from sticking to a skin surface. The second switch 60 is connected to the circuit by way of a wire attached across the leads of the switch that connects to the hand-held trigger. Resistor R2 64 is 100 ohms and resistor R3 66 and R4 68 are both 20 k ohms. Capacitor 70 is 224J 400VDC. The circuit also includes transistor 72 and step-up transformer 74 the high voltage side of which is connected to capacitor 70.

Referring to FIG. 7, there is shown one example of the invention 78 similar to that shown in FIG. 3, with the hand switch 80 comprising a body 82 a thumb button 84 and a spring 86 connected to the body 16 of the device by wire 88. The body is grasped by the hand and the device cannot be discharged until the wearer depresses thumb button 84.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A personal security device comprising:
a. a body having a sloped front face and a vertical rear face;
b. means for power storage in electrical communication with said body;
c. means for generating a discharge voltage; and,
d. means for discharging said discharge voltage onto the skin of an attacker sufficient to deter said attacker without tissue damage, wherein said personal security device is worn securely on the person.

2. The personal security device of claim 1, wherein said personal security device is a bracelet for wearing on the wrist of a person and secured thereto by an adjustable strap.

3. The personal security device of claim 2, wherein said sloped front face has an angle adapted for optimum exposure of said means for discharging the discharge voltage onto the skin of an attacker.

4. The personal security device of claim 3 wherein the sloped front face has an angle of approximately 60 degrees from the vertical and wherein said skin of the attacker is facial skin.

5. The personal security device of claim 4, wherein means for discharging the discharge voltage comprises a first exposed electrode and an adjacent second exposed electrode adapted for communicating the discharge voltage onto the skin of the attacker when said first and second exposed electrodes protrude from the sloped front face of the body; and, wherein the first and second exposed electrodes are adapted for simultaneous contact with the skin of the attacker.

6. The personal security device of claim 5 wherein the first and second exposed electrodes are in electrical communication with an at least one discharge voltage storage capacitor disposed within said body of the device.

7. The personal security device of claim 6, wherein said means for power storage comprises an at least one battery in communication with said means for generating a discharge voltage, wherein said at least one battery is contained in an at least one battery casing fixed adjacent to the body.

8. The personal security device of claim 7 wherein the at least one battery is contained in an at least one battery magazine disposed remote from the body and electrically connected thereto by a suitable conductor.

9. The personal security device of claim 8, wherein the means for generating a discharge voltage comprises an electrical circuit housed within the body and comprising an at least one transformer having a low voltage side in communication with the at least one battery and a discharge voltage side in communication with said at least one discharge voltage storage capacitor.

10. The personal security device of claim 9 wherein the discharge voltage stored in the at least one discharge voltage storage capacitor is around 1500 volts.

11. The personal security device of claim 10, wherein the electrical circuit further comprises an on/off switch connecting the at least one battery to said electrical circuit, wherein said on/off switch is disposed on said vertical back face.

12. The personal security device of claim 11, wherein the electrical circuit further comprises a discharge button to discharge the at least one discharge voltage storage capacitor so that the security device can be safety stowed, wherein said discharge button is disposed on the vertical back face; and, a light emitting diode having a first illuminated mode to show the device in an “on” mode and a second extinguished mode to the device in an “off” mode.

13. A personal security device comprising:
a. a bracelet having an adjustable strap for wrist attachment;
b. said bracelet attached to a body having a sloped front face of about 60 degrees from the vertical and a vertical rear face;
c. at least one battery for power storage in electrical communication with said body, said at least one battery having adequate capacity to supply voltage to;
d. a low voltage side of at least one transformer for generating a discharge voltage on a high voltage side of about 1500 volts, said transformer disposed within the body and said high voltage side in communication with;
e. at least one discharge voltage storage capacitor disposed within the body, said at least one discharge voltage storage capacity in electrical contact with;
f. a first exposed electrode and an adjacent second exposed electrode adapted for communicating the discharge voltage onto the skin of the attacker when said first and second exposed electrodes protrude from the sloped front face of the body; and, wherein the first and second exposed electrodes are adapted for simultaneous contact with the skin of the attacker.

14. The personal security device of claim 13, wherein the electrical circuit further comprises:
a. an on/off switch connecting the at least one battery to said electrical circuit, wherein said on/off switch is disposed on said vertical back face;
b. a discharge button to discharge the at least one discharge voltage storage capacitor so that the security device can be safety stowed, wherein said discharge button is disposed on the vertical back face;
c. a first light emitting diode having a first illuminated mode to show the device in an “on” mode and a second extinguished mode to the device in an “off” mode; and,
d. a second light emitting diode having a first illuminated mode to show the device on a fully charged mode and a second extinguished mode to show the device in a discharged mode.

15. The personal security device of claim 14 further comprising a hand held switch having a spring loaded thumb button, said hand held switch disposed between the at least one battery and the at least one transformer by a suitable wire connector so that when the device is in a fully charged state said spring loaded thumb button must be depressed to close the hand held switch in order to discharge the discharge voltage.
